(19) United States
(12) Patent Application Publication
(10) Pub. No.: US 2011/0260832 A1
(43) Pub. Date: Oct. 27, 2011

(54) SECURE VOICE BIOMETRIC ENROLLMENT AND VOICE ALERT DELIVERY SYSTEM

(76) Inventors: Joe Ross, Austin, TX (US); Isaac Chapa, Austin, TX (US); Adrian Cruz, Austin, TX (US); Harold E. Gottschalk, JR., El Cajon, CA (US)

(21) Appl. No.: 13/093,664

(22) Filed: Apr. 25, 2011

Related U.S. Application Data
(60) Provisional application No. 61/328,361, filed on Apr. 27, 2010.

(51) Int. Cl. G06F 7/04; G10L 13/08; H04M 1/56

(52) U.S. Cl. 340/5.84; 379/142.05; 704/260; 704/E13.001

(57) ABSTRACT

In one embodiment, a method includes enrolling a potential enrollee for an identity-monitoring service. The enrolling includes acquiring personally-identifying information (PII) and capturing a voiceprint. Following successful completion of the enrolling, the potential enrollee is an enrollee. The method further includes, responsive to an identified suspicious event related to the PII, creating an identity alert, establishing voice communication with an individual purporting to be the enrollee, and performing voice-biometric verification of the individual. The voice-biometric verification includes comparing one or more spoken utterances with the voiceprint. Following successful completion of the voice-biometric verification, the individual is a verified enrollee. In addition, the method includes authorizing delivery of the identity alert to the verified enrollee.

### CROSS-REFERENCE TO RELATED APPLICATIONS

This Application claims priority from, and incorporates by reference the entire disclosure of, U.S. Provisional application No. 61/328,361 filed on Apr. 27, 2010.

### BACKGROUND

1. Technical Field

The invention relates generally to information security and more particularly, but not by way of limitation, to systems and methods for voice-biometric enrollment and voice-alert delivery.

2. History Of Related Art

Identity theft is one of the fastest-growing crimes in the United States and worldwide. Identity theft generally involves a use of personally-identifying information (PII) that is not authorized by an owner of the PII. PII, as used herein, refers to information that can be used to uniquely identify, contact, or locate a person or can be used with other sources to uniquely identify, contact, or locate a person. PII may include, but is not limited to, social security numbers (SSN), bank or credit card account numbers, passwords, birth dates, and addresses. Identity theft may include, for example, an unauthorized change to PII or an unauthorized use of PII to access resources or to obtain credit or other benefits.

Businesses and consumers alike are victims of identity-theft crimes. For example, in 2008, approximately ten million U.S. adults were victims of identity theft and businesses suffered approximately $56 billion as a direct result thereof. The Identity Fraud Survey Report created by Javelin Strategy & Research found that victims averaged a personal cost of $373 and 21 hours of time to resolve their identity fraud issues in 2009. The annual cost of identity theft currently exceeds $200 billion worldwide. Given that identity theft is a high-reward/low-risk crime as described by the Federal Bureau of Investigation (FBI), it appears that identity theft will continue to increase.

Since identity theft affects both businesses and consumers, there is a need to quickly and securely alert or notify consumers of potential identity theft. However, in the prior art, alerts are often delivered with minimal security. For example, a typical prior art system may only require a telephone number prior to delivery of an identity alert. Therefore, in the prior art, there is a substantial risk that alerts will be delivered to an incorrect party.

### SUMMARY OF THE INVENTION

In one embodiment, a method includes enrolling a potential enrollee for an identity-monitoring service. The enrolling includes acquiring personally-identifying information (PII) and capturing a voiceprint. Following successful completion of the enrolling, the potential enrollee is an enrollee. The method further includes, responsive to an identified suspicious event related to the PII, creating an identity alert, establishing voice communication with an individual purporting to be the enrollee, and performing voice-biometric verification of the individual. The voice-biometric verification includes comparing one or more spoken utterances with the voiceprint. Following successful completion of the voice-biometric verification, the individual is a verified enrollee. In addition, the method includes authorizing delivery of the identity alert to the verified enrollee.

In one embodiment, a voice-biometric system includes an interactive voice-response (IVR) system operable to exchange voice communication with a communication device over a network. The voice-biometric system further includes a voice-alert system (VAS) communicably coupled to the IVR system via a computer network. The VAS is operable, in conjunction with the IVR system, to enroll a potential enrollee for an identity-monitoring service. The enrollment includes acquiring personally-identifying information (PII) and capturing a voiceprint. Following successful completion of the enrolling, the potential enrollee is an enrollee. The VAS is further operable, responsive to an identified suspicious event related to the PII, to create an identity alert, establish voice communication with an individual purporting to be the enrollee, and perform voice-biometric verification of the individual. The voice-biometric verification includes comparing one or more spoken utterances with the voiceprint. Following successful completion of the voice-biometric verification, the individual is a verified enrollee. Additionally, the VAS is operable to authorize delivery of the identity alert to the verified enrollee.

In one embodiment, a computer-program product includes a computer- usable medium having computer-readable program code embodied therein. The computer- readable program code adapted to be executed to implement a method. The method includes enrolling a potential enrollee for an identity-monitoring service. The enrolling includes acquiring personally-identifying information (PII) and capturing a voiceprint. Following successful completion of the enrolling, the potential enrollee is an enrollee. The method further includes, responsive to an identified suspicious event related to the PII, creating an identity alert, establishing voice communication with an individual purporting to be the enrollee, and performing voice-biometric verification of the individual. The voice-biometric verification includes comparing one or more spoken utterances with the voiceprint. Following successful completion of the voice-biometric verification, the individual is a verified enrollee. In addition, the method includes authorizing delivery of the identity alert to the verified enrollee.

The above summary of the invention is not intended to represent each embodiment or every aspect of the present invention.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 describes a system that may be utilized for identity-monitoring enrollment and identity-alert delivery;

FIG. 2 describes an illustrative mixed-mode enrollment method;

FIG. 3 describes an illustrative full-voice-mode enrollment method;

FIG. 4 describes an illustrative identity-alert method that utilizes full-voice mode;

FIG. 5 describes an illustrative identity-alert method that utilizes full-voice mode;

FIG. 6 describes an illustrative identity-alert method that utilizes mixed mode;

FIG. 7 describes an illustrative identity-alert method; and

FIG. 8 illustrates an embodiment of a computer system.

### DETAILED DESCRIPTION OF ILLUSTRATIVE EMBODIMENTS OF THE INVENTION

Various embodiments of the present invention will now be described more fully with reference to the accompanying drawings. The invention may, however, be embodied in many different forms and should not be constructed as limited to the embodiments set forth herein; rather, the embodiments are provided so that this disclosure will be thorough and complete, and will fully convey the scope of the invention to those skilled in the art.

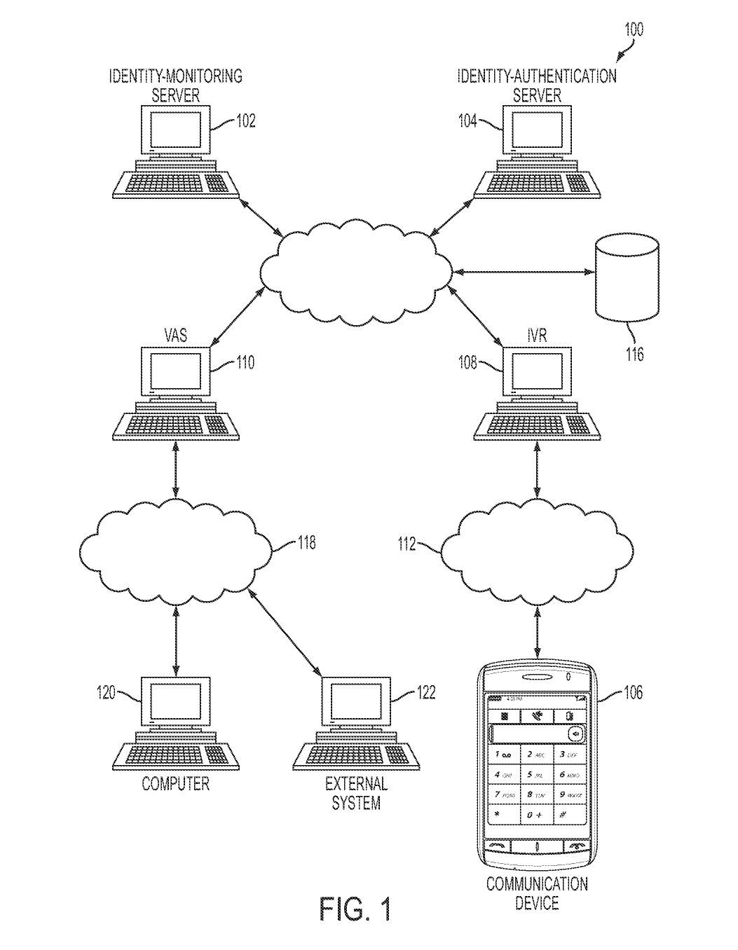

FIG. 1 describes a system 100 that may be utilized for identity-monitoring enrollment and identity-alert delivery. The system 100 includes an identity-monitoring system 102, an identity-authentication server 104, a communication device 106, an interactive voice response (IVR) system 108, a Voice Alert and Biometric System (VAS) 110, an enrollee database 116, a computer 120, and an external system 122. In a typical embodiment, the communication device 106 is operable to communicate with the IVR system 108 via a network 112 that is capable of carrying voice communication such as, for example, a public switch telephone network (PSTN), a cellular network, or the Internet. In a typical embodiment, the identity-monitoring system 102, the identity-authentication server 104, the IVR system 108, and the enrollee database 116 are operable to securely communicate, for example, via a computer network 114.

In a typical embodiment, the system 100 provides identity-protection services to enrollees of the system 100. An enrollee, as used herein, is an individual who has registered with the system 100 and has passed applicable security prerequisites for enrollment such as, for example, an identity-verification process. A potential enrollee, as used herein, is an individual who has started but not yet completed enrollment into the system 100. A purported enrollee, as used herein, is an individual who purports to be an enrollee of the system 100 but has not been verified as an enrollee by the system 100. Once a purported enrollee has been verified by the system 100 as an enrollee, the purported enrollee may be referenced herein as a verified enrollee.

For purposes of illustration, various networks are illustrated in FIG. 1. However, one of ordinary skill in the art will appreciate that the depicted networks are illustrative in nature and should not be interpreted to mean that each network is necessarily separate or mutually exclusive from another network. For example, the network 114, the network 118, and the network 112 are illustrated separately in FIG. 1. However, in various embodiments, the network 114, the network 118, and the network 112 may each comprise part of the Internet. In various other embodiments, the network 114, the network 118, and the network 112 may be separate networks.

In addition, for purposes of illustration, various computers or computer systems are illustrated in FIG. 1 such as, for example, the identity-monitoring system 102, the identity-authentication server 104, the interactive voice response (IVR) system 108, and the VAS 110. One of ordinary skill in the art will appreciate that each instance of a computer or computer system may, in various embodiments, represent a plurality of server computers. Likewise, although various server computers are illustrated separately in FIG. 1, in various embodiments, fewer server computers may be utilized. For example, in various embodiments, the IVR system 108 and the VAS 110 may be resident and operating on one physical or virtual server computer.

The IVR system 108 is typically operable to exchange voice communication with the communication device 106 over the network 112. The communication device 106 may be, for example, a wireline telephone, a wireless telephone, a smartphone telephone, a voice-over-internet-protocol (VOIP) telephone, a satellite telephone, a personal computer (PC), or any other device capable of receiving and transmitting voice communication. The communication device 106 is generally controlled by a caller such as, for example, a purported enrollee or a potential enrollee of the system 100. In a typical embodiment, the IVR system 108 is operable to perform text-to-speech (TTS) conversion and automated speech recognition (ASR) in order to communicate with the communication device 106. In a typical embodiment, the IVR system 108 employs dual-tone multi-frequency (DTMF) signaling and thus is operable to recognize, for example, touch-tone responses from the communication device 106. The IVR system 108 may include, for example, one or more VoiceXML (VXML) server computers.

Additionally, in a typical embodiment, the IVR system 108 is operable to utilize voice-biometric technology to capture voiceprints and verify, for example, purported enrollees, by way of the voiceprints. A voiceprint, as used herein, is a set of measurable characteristics of a human voice that uniquely identifies an individual. During enrollment, for example, of a potential enrollee, the IVR system 108 is typically operable to capture and store a voiceprint for the potential enrollee. During verification, for example, of a purported enrollee, the IVR system 108 is typically operable to verify the purported enrollee as an enrollee of the system 100 via the voiceprint. For example, in various embodiments, the IVR system 108 may prompt the purported enrollee to speak certain utterances (e.g., a random sequence of digits) and analyze the speech against the voiceprint.

In a typical embodiment, the identity-verification server 104 is operable to authenticate a purported enrollee or a potential enrollee via, for example, knowledge-based authentication (KBA) questions. KBA questions are generally considered to be questions or combinations of questions that only a person having a particular identity should be able to answer. In various embodiments, the identity-verification server 104 is operable to generate KBA questions from data records corresponding to an identity such as, for example, an identity being asserted by a potential enrollee or a purported enrollee. For example, in various embodiments, KBA questions may be generated in real time and based on information in public records, compiled marketing data, and/or credit reports for the identity being asserted. In some embodiments, the identity-verification server 104 may, for example, provide knowledge-based authentication as a subscription-based service.

In a typical embodiment, the identity-monitoring system 102 is operable to identify suspicious events related to enrollees' personally-identifying information (PII). PII, as used herein, refers to information that can be used to uniquely identify, contact, or locate an individual person or can be used with other sources to uniquely identify, contact, or locate an individual person. PII may include, but is not limited to, social security numbers (SSN), bank or credit card account numbers, passwords, birth dates, and addresses. A suspicious event may be, for example, a change to PII or a use of PII to access resources or to obtain credit or other benefits. A suspicious event may also be an event that is detected via PII such as, for example, a criminal or sex-offender event that is found in court records, police records, a sex-offender registry, and the like.

In a typical embodiment, the identity-monitoring system 102 notifies the VAS 110 of identified suspicious events. In various embodiments, the VAS 110 may evaluate the identified suspicious events and determine whether identity alerts are merited. If so, identity alerts may be generated for appropriate enrollees. In various embodiments, the VAS 110 may allow rules to be established and configured regarding, for example, events that do or do not merit identity alerts. In some embodiments, the rules are further configurable by enrollees. For example, in some embodiments, rule may be configured such that alerts are generated for deemed significant events such as, for example, the opening of a new account, but not for deemed insignificant events such as, for example, a credit inquiry.

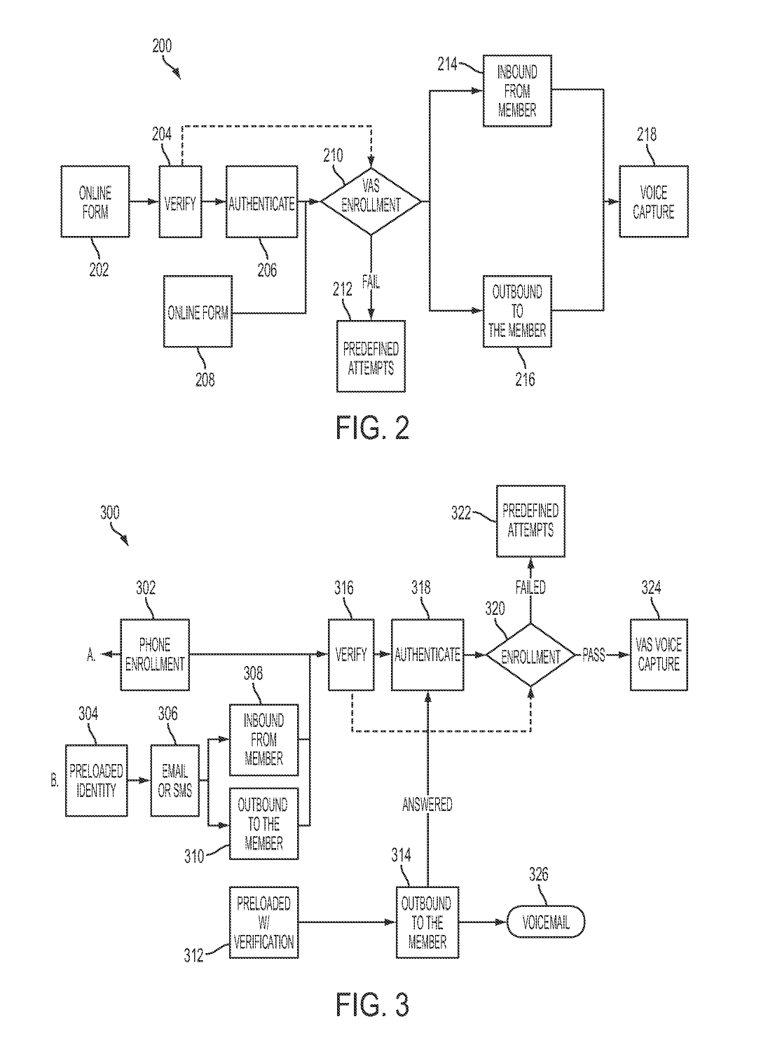

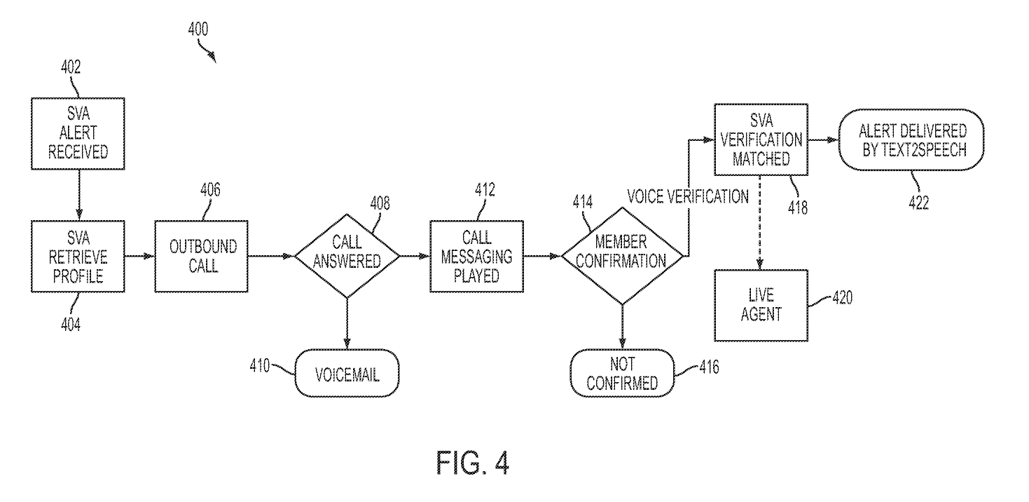

The VAS 110 is typically operable to centrally manage enrollment into the system 100, monitoring of enrollees' identities, and delivery of alerts such as, for example, identity alerts, to enrollees. The VAS 110 is typically operable to direct the identity-authentication server 104 and the IVR system 108 to enroll a potential enrollee into the system 100 and store, for example, a voiceprint for the potential enrollee in the enrollee database 116. In a typical embodiment, the enrollee database 116 is an encrypted database. Examples of enrollment of potential enrollees will be described in detail with respect to FIGS. 2 and 3. Upon receipt, for example, of information related to a suspicious event for an enrollee from the identity-monitoring system 102, the VAS 110 is typically operable to direct the IVR system 108 to deliver an identity alert to the enrollee via the network 112 and the communication device 106. Examples of identity-alert delivery will be described in detail with respect to FIGS. 4-7.

In a typical embodiment, the VAS 110 may further operate as a web server and serve web pages to the computer 120 over the network 118. The network 118 may be, for example, Internet-based. The computer 120 may be, for example, a desktop computer, a laptop computer, a smartphone, or the like. In various embodiments, the computer 120 may be operated by, for example, a potential enrollee or a purported enrollee. Additionally, in various embodiments, the computer 120 may be operated at a kiosk by, for example, an agent for a business that utilizes the system 100. The agent may, for example, orally communicate with potential enrollees and purported enrollees of the system 100.

Additionally, in embodiments in which the VAS 110 operates as a web server, the VAS 110 may serve a web form, for example, to an operator, analyst, or agent, so that a secure message or alert may be entered for delivery to an enrollee via the system 100. For example, in various embodiments, an agent may work to restore an identity of an enrollee that is an identity-theft victim. In these embodiments, the agent may use the web form served by the VAS 110 to ensure that a secure message is delivered to the enrollee.

In addition, in a typical embodiment, the VAS 110 may provide an application programming interface (API) service over the network 118. The API service may allow external systems such as, for example, the external system 122, to provide alerts for identity-alert delivery by the system 100. In various embodiments, the API service may be, for example, XML-based. The external system 122 may be, for example, a system of a financial institution, a governmental entity, or another organization. An example of identity-alert delivery via the API service is described in detail with respect to FIG. 4.

The VAS 110 may include, for example, a cluster of active and passive application servers and/or database servers. In a typical embodiment, active application servers and database servers are primary sources, while the remaining servers are passive sources. If the primary source fails, the passive source detects the failure(s) and then assumes a role of the primary source. One of ordinary skill in the art will appreciate that, in some embodiments, passive application servers and/or database servers may not be utilized.

FIG. 2 shows an illustrative mixed-mode enrollment method 200 that may utilize, for example, the system 100 of FIG. 1. A mixed-mode enrollment method is an enrollment method that utilizes a combination of two or more means of communication. For example, in the illustrative mixed-mode enrollment method 200, Internet communication may be utilized for steps 202-210 and telephone communication may be utilized for steps 214-218. One of ordinary skill in the art will appreciate that the method 200 is exemplary and that, in various embodiments, various steps may be substituted, added, or eliminated.

In various embodiments, the method 200 may begin at either step 202 or step 208. At step 202, a system such as, for example, the VAS 110 of FIG. 1, receives an online data form from a potential enrollee in connection with a request for services provided by, for example, the system 100. In a typical embodiment, the online data form may be received via a secure website on the Internet that is in communication with a computer such as, for example, the computer 120 of FIG. 1. In a typical embodiment, the online data form includes PII for the potential enrollee. The PII may include, for example, a name, address, social security number (SSN), and date of birth. From step 202, the method 200 proceeds to step 204.

At step 204, the PII from the online data form is verified for correctness. In a typical embodiment, the verification for correctness involves utilizing, for example, the identity-verification server 104 of FIG. 1, to verify accuracy and consistency of the PII. For example, the PII may be compared with information in public records, compiled marketing data, and/or credit reports in order to determine, for example, whether each element of the PII exists and whether each element of the PII properly corresponds to other elements of the PII. For example, records may be referenced to confirm that a social security number that is provided in the PII belongs to a person having a name provided in the PII. In addition, the PII may be compared with records corresponding, for example, to known stolen identities.

In various embodiments, during the verification at step 204, a score may be developed for the PII and compared to a pre-established threshold. In a typical embodiment, the score represents a relative confidence that each element of the PII is accurate and consistent with a single identity. In various embodiments, the score may be based on, for example, the frequency at which elements of the PII occur in a single data record. Specific scoring algorithms may be implemented using pre-established business rules.

If the score exceeds the predetermined threshold, the PII provided by the potential enrollee may be considered to have passed the verification and the method 200 may proceed to step 206. Alternatively, if the score does not exceed the predetermined threshold, the PII provided by the potential enrollee may be considered to have failed the verification and the failure may be recorded in computer-readable storage. In a typical embodiment, if the verification results in failure, the method 200 may, as an optimization, skip step 206 and proceed directly to step 210.

If the score computed at step 204 exceeds the predetermined threshold, at step 206, the potential enrollee may be authenticated in order to ensure that an identity being asserted belongs to the potential enrollee. By way of example, in a typical embodiment, authentication may involve creation of KBA questions, solicitation of answers to the KBA questions from the potential enrollee, and verification that the answers to the KBA questions are correct. In various embodiments, the identity-verification server 104 is operable to generate the KBA questions using data records accessed via, for example, the PII provided by the potential enrollee. For example, in various embodiments, the KBA questions may be generated from information in public records, compiled marketing data, and/or credit reports for the identity being asserted. Therefore, the KBA questions may relate to, for example, loan information, insurance information, previous addresses and phone numbers, and other information that generally only the owner of a particular identity should know. In a typical embodiment, the KBA questions help ensure that the potential enrollee is who they are claiming to be by way of the PII.

In a typical embodiment, answers to the KBA questions may be solicited and obtained via an online data form presented to the potential enrollee over the Internet. In a typical embodiment, the answers from the potential enrollee may be scored and compared to a predetermined threshold. If the score fails to exceed the predetermined threshold, the authentication results in failure and the failure may be recorded in computer-readable storage. However, if the score exceeds the predetermined threshold, the authentication results in success and the success may be recorded in computer-readable storage. From step 206, the method 200 proceeds to step 210.

As described above, in various embodiments, the method 200 may begin at step 208. In these embodiments, step 208 is performed as an alternative to steps 202-206 described above. At step 208, a system such as, for example, the VAS 110 of FIG. 1, receives an online data form from the potential enrollee as described above with respect to step 202. However, at step 208, the potential enrollee may be manually verified and authenticated according to various predetermined manual verification and authentication procedures that an entity may have. For example, the potential enrollee may be verified and authenticated by an agent at a kiosk who asks KBA questions and/or visually inspects identity documentation (e.g., driver's license). By way of further example, the potential enrollee may be manually verified and authenticated by calling a telephone number to speak to an agent. After step 208, the method 200 proceeds to step 210.

Steps 204, 206, and 208 are included and described above in order to provide examples of security features that may be included in the method 200. In that way, in various embodiments, steps 204, 206, and/or 208 may help ensure that the potential enrollee is asserting an identity that belongs to the potential enrollee. However, it is explicitly contemplated that, in various embodiments, steps 204, 206, and/or 208 may be supplemented with or replaced by other security methods that have similar objectives. Additionally, in various embodiments, steps such as steps 204, 206, and 208 may be rearranged or performed at different stages of a method such as, for example, the method 200.

At step 210, a system such as, for example, the VAS 110 of FIG. 1, may determine a next step in the method 200. If the verification at step 204 or the authentication at step 206 results in failure, in various embodiments, the potential enrollee may be given a predefined number of attempts to correct the failure at step 212. In some embodiments, a system such as, for example, the system 100 of FIG. 1, may be configured to not allow the potential enrollee to have additional attempts to correct failures at one or both of steps 204 and 206. If the predefined number of attempts has been reached or additional attempts are not allowed, in a typical embodiment, the method 200 ends without the potential enrollee being enrolled in the system 100.

If the verification at step 204 and the authentication at step 206 have both resulted in success, at step 210 a system such as, for example, the VAS 110 of FIG. 1, may prompt the potential enrollee to select an option for engaging in voice communication so that a voice-biometric process in steps 214-216 may occur. In a typical embodiment, the voice-biometric process involves capture and storage of a voiceprint for the potential enrollee. For example, the potential enrollee may be prompted via a web page served by the VAS 110 to choose between placing an inbound call, for example, to the system 100, and having the system 100 place an outbound call to the potential enrollee.

If, at step 210, the potential enrollee chooses to place an inbound call to the system 100, the VAS 110 may provide a call-in number to the potential enrollee via a webpage and the method 200 proceeds to step 214. The call-in number may be, for example, a dedicated call-in number or a randomly-generated call-in number. In various embodiments, the VAS 110 may provide a reference code or password with the call-in number for entry by the potential enrollee. At step 214, a system such as, for example, the IVR system 108 of FIG. 1, receives the inbound call from the potential enrollee and communicates with the VAS 110. In a typical embodiment, the VAS 110 may direct that the IVR system 108 verify the potential enrollee, for example, by requiring entry of the reference code or password. After step 214, the method 200 proceeds to step 218 for capture and storage of the voiceprint.

If, at step 210, the potential enrollee chooses to have the system 100 place an outbound call to the potential enrollee, the VAS 110 may, via one or more web pages, confirm a telephone number for the potential enrollee and the method 200 proceeds to step 216. At step 216, the VAS 110 may direct the IVR system 108 to dial the telephone number for the potential enrollee. In a typical embodiment, the VAS 110 may further direct that the IVR system 108 verify the potential enrollee, for example, by requiring entry of the reference code or password. After step 216, the method 200 proceeds to step 218 for capture and storage of the voiceprint.

At step 218, the VAS 110 may direct the IVR system 108 to capture the voiceprint for the potential enrollee. To capture the voiceprint, in a typical embodiment, the IVR system 108 may prompt the potential enrollee to utter a series of phrases. In various embodiments, the series of phrases may be independent or dependent phrases. An independent phrase refers randomly-generated speech or numbers that a speaker is asked to repeat. A dependent phrase refers to a static phrase such as, for example, the speaker's phone number or “my voice is my password.” In various embodiments, particular phrases, a number of phrases, and phrase length are each configurable. In a typical embodiment, the IVR system 108 captures the voiceprint for the potential enrollee and the VAS 110 saves the voiceprint within the enrollee database 116 along with a unique identifier associated with the potential enrollee.

In a typical embodiment, the VAS 110 may further cause the IVR system 108 to prompt the enrollee to select from a menu of options for receiving identity alerts when, for example, a suspicious event is identified. As described in more detail with respect to FIGS. 4-7, in various embodiments, the menu of options may include, for example, an outbound call to the enrollee, an email or text message with a URL to a web portal, an email or text message with instructions for calling the IVR 108, or the like. Following step 218, the potential enrollee is an enrollee, for example, in the system 100, and the method 200 ends.

In various embodiments, an agent of a business that utilizes, for example, the system 100, may interact with the system 100 in place of the purported enrollee using, for example, a computer terminal located at a kiosk. For example, the computer terminal may be similar to the computer 120 of FIG. 1. In these embodiments, the agent may directly collect from the potential enrollee, for example, the PII, the answers to the KBA questions and other required information, and provide the information to the system 100 as described with respect to the method 200. Additionally, in various embodiments, the agent may provide security in addition to the authentication at step 206 by requiring, for example, a photo identification and/or other documentary evidence of the PII.

FIG. 3 shows an illustrative full-voice-mode enrollment method 300. Full-voice-mode enrollment refers to an enrollment method that typically utilizes only voice communication to extract information from a potential enrollee for purposes of enrollment in a system such as, for example, the system 100. One of ordinary skill in the art will appreciate that the method 300 is exemplary and that, in various embodiments, various steps may be substituted, added, or eliminated. In various embodiments, the method 300 may begin at step 302, step 304, or step 312.

At step 302, the method 300 begins via, for example, an inbound call from the potential enrollee to the IVR system 108 of FIG. 1. PII similar to that described with respect to step 202 of FIG. 2 may be collected using ASR and/or DTMF functionality of an IVR such as, for example, the IVR system 108 of FIG. 1. In that way, the IVR system 108 may obtain the PII, for example, by way of the potential enrollee's speech or touch-tone responses from the potential enrollee. After step 302, the method 300 proceeds to step 316 for verification of the PII.

At step 316, the PII is verified, for example, as described with respect to step 204 of FIG. 2. In a typical embodiment, if the verification results in failure, the method 300 may, as an optimization, skip step 318 and proceed directly to step 320. Otherwise, if the verification does not result in failure, the method 300 proceeds to step 318. At step 318, the potential enrollee is authenticated as described with respect to step 206 of FIG. 2. However, in contrast to step 206 of FIG. 2, at step 318 answers to KBA questions may be presented via TTS-conversion capabilities of an IVR such as, for example, the IVR system 108 of FIG. 1. In a similar manner, answers to KBA questions may be obtained via, for example, ASR and DTMF functionality of the IVR system 108 of FIG. 1. In that way, the IVR system 108 may obtain the KBA answers, for example, by way of the potential enrollee's speech or by way of touch-tone responses from the potential enrollee. After step 318, the method 300 proceeds to step 320.

Steps 316 and 318 are included and described above in order to provide examples of security features that may be included in the method 300. In that way, in various embodiments, steps 316 and/or 318 may help ensure that the potential enrollee is asserting an identity that belongs to the potential enrollee. However, it is explicitly contemplated that, in various embodiments, steps 316 and/or 318 may be supplemented with or replaced by other security methods that have similar objectives. Additionally, in various embodiments, steps such as steps 316 and 318 may be rearranged or performed at different stages of a method such as, for example, the method 300.

At step 320, if the verification at step 316 or the authentication at step 318 results in failure, in various embodiments, the potential enrollee may be given a predefined number of attempts to correct the failure at step 322. In some embodiments, a system such as, for example, the system 100 of FIG. 1, may be configured to not allow the potential enrollee to have additional attempts to correct the failures at one or both of steps 316 and 318. If the predefined number of attempts has been reached or additional attempts are not allowed, in a typical embodiment, the method 300 ends without the potential enrollee being enrolled in the system 100. If the verification at step 316 and the authentication at step 318 results in success, the method 300 proceeds to step 324 for creation of a voiceprint.

At step 324, the VAS 110 may direct the IVR system 108 to capture the voiceprint for the potential enrollee. To capture the voiceprint, in a typical embodiment, the IVR system 108 may prompt the potential enrollee to utter a series of phrases. In various embodiments, the series of phrases may be independent or dependent phrases as described above with respect to step 218 of FIG. 2. In various embodiments, the phrases, a number phrases, and phrase length are configurable. In a typical embodiment, the IVR system 108 captures the voiceprint for the potential enrollee and saves the voiceprint within an encrypted database or file system along with a unique identifier associated with the potential enrollee. Following step 324, the potential enrollee is an enrollee, for example, in the system 100, and the method 300 ends.

As an alternative to step 302 as described above, in various embodiments, various steps selected from steps 304-310 may be performed. At step 304, the method 300 may begin with the PII of the potential enrollee pre-loaded into the system via, for example, an import file. In various embodiments, a business such as, for example, a financial institution, may have previously obtained the PII for the potential enrollee. Thus, the business may be able to import the PII into the system via, for example, the import file. In that way, in a typical embodiment, it is not necessary for the potential enrollee to provide the PII in the manner set forth with respect to step 302. After step 304, the method 300 proceeds to step 306.

At step 306, the VAS 110 of FIG. 1 may send a message such as, for example, an email message or a short message system (SMS) text message, to the potential enrollee. In a typical embodiment, the message may contain a call-in number and a reference code or password. Depending on how a system such as, for example, the system 100, is configured, following step 306, the method 300 proceeds to either step 308 or step 310. In a typical embodiment in which the method 300 proceeds to step 308, the VAS 110, via the IVR system 108, receives an inbound call from the potential enrollee and prompts the potential enrollee to enter the reference code or password. Following step 308, the method 300 proceeds to step 316 and the method 300 proceeds as described above.

In various embodiments, an error may occur that prevents the message sent at step 306 from being transmitted or delivered to the potential enrollee. Similarly, in various embodiments, an error may be presumed by a failure of the potential enrollee to call in to the call-in number within a predetermined period of time. In these embodiments, at step 310, the VAS 110 may direct the IVR system 108 to initiate an outbound call to the potential enrollee. From step 310, the method 300 proceeds to step 316 and the method 300 proceeds as described above.

In various embodiments, as another alternative to step 302 as described above, the method 300 may begin with step 312. At step 312, the method 300 may begin with the PII of the potential enrollee pre-loaded into the system via, for example, an import file as described above with respect to step 304. Additionally, the PII may be pre-verified so that step 316 does not need to occur. From step 312, the method 300 proceeds to step 314. At step 314, the VAS 110 may direct the IVR system 108 to initiate an outbound call to the potential enrollee via, for example, a telephone number in the PII. If a live person answers the call, the method 300 proceeds to step 318 and proceeds as described above.

If, at step 314, a live person does not answer the call and the call is directed to voicemail, the method 300 proceeds to step 326. At step 326, a voice message with a call-in number and a reference code or password may be left with the potential enrollee's voicemail. At a subsequent time, the potential enrollee may call in to the call-in number as described with respect to step 308 above. After step 326, the method 300 ends.

FIGS. 4-7 show various illustrative methods of delivering identity alerts to enrollees of the system 100. FIG. 4 describes an illustrative identity-alert method 400 that utilizes full-voice mode. Full-voice-mode identity alerts refer to an identity-alert method that typically utilizes only voice communication to provide identity alerts to enrollees of a system such as, for example, the system 100 of FIG. 1. One of ordinary skill in the art will appreciate that the method 400 is exemplary and that, in various embodiments, various steps may be substituted, added, or eliminated.

In FIG. 4, the method 400 begins at step 402. At step 402, a system such as, for example, the VAS 110 of FIG. 1, receives an alert for transmission to an enrollee. In various embodiments, the alert may be an identity alert triggered, for example, by a suspicious event identified by the identity-monitoring server 102 of FIG. 1. In various other embodiments, the alert may be an alert provided by an external system such as, for example, the external system 122 of FIG. 1. The external system 122 may be, for example, a system of a financial institution, a governmental entity, or another organization. The external system 122 may access the VAS 110 via, for example, the API of the VAS 110.

After step 402, the method 400 proceeds to step 404. At step 404, the VAS 110 confirms that an enrollee to whom the alert corresponds is registered to receive voice alerts and has a voiceprint on file in the system 100. If so, the VAS 110 accesses, for example, a telephone number for the enrollee. After step 404, the method 400 proceeds to step 406. At step 406, the VAS 110 directs, for example, the IVR system 108 of FIG. 1, to initiate an outbound call to the telephone number accessed for the enrollee. From step 406, the method 400 proceeds to step 408.

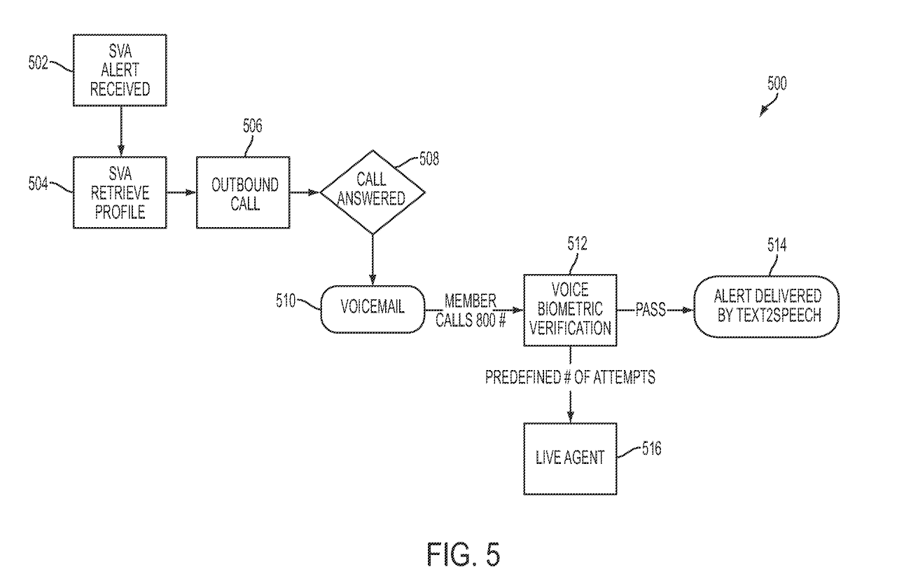

At step 408, the IVR system 108 determines a call-answer disposition for the outbound call. If the IVR system 108 determines that the outbound call is answered by voicemail, the method 400 proceeds to step 410. At step 410, a voice message with a call-in number and a reference code or password may be left with the voicemail. At a subsequent time, the enrollee may call in to the call-in number and enter the reference code or password for retrieval of the alert. An exemplary embodiment utilizing voicemail is described in more detail with respect to FIG. 5. If the IVR system 108 determines at step 408 that the outbound call is answered by a live person, the method 400 proceeds to step 412.

At step 412, the IVR system 108 plays a message to the live person who answered the outbound call. In a typical embodiment, the message explains that an alert for a particular person is ready for presentation and asks whether the live person who answered the outbound call is that particular person. In a typical embodiment, the IVR system 108 further allows the live person to answer affirmatively or negatively via speech (e.g., “yes” or “no”) or touch-tone responses (e.g.. ‘1’ or ‘2’). In a typical embodiment, a response from the live person may be recognized via, for example, ASR and DTMF functionality of the IVR system 108 of FIG. 1. After step 412, the method 400 proceeds to step 414.

At step 414, the IVR system 108 receives the response from the live person. If the response indicates that the live person is not the particular person to whom the alert corresponds, the method 400 proceeds to step 416 and the method 400 ends. Alternatively, if the response indicates that live person is the particular person to whom the alert corresponds, the live person may be considered a purported enrollee and the method 400 proceeds to step 418.

At step 418, in a typical embodiment, the VAS 110 causes the IVR system 108 to perform voice-biometric verification of the purported enrollee. In a typical embodiment, the IVR system 108 may prompt the purported enrollee to speak certain utterances (e.g., a random sequence of digits) and analyze the speech against a voiceprint for the particular person to whom the alert corresponds. In various embodiments, an option may be provided to allow the purported enrollee to opt out of voice-biometric verification (e.g., by pressing ‘*’ or speaking “skip”) and be transferred to a live agent for manual verification at step 420. At step 420, the live agent may manually verify the purported enrollee and, if the manual verification is successful, read or otherwise manually cause the alert to be delivered. After step 420, the method 400 ends.

In a typical embodiment, the IVR system 108 is operable to return a “pass” or a “fail” to the VAS 110 as a result of the voice-biometric verification. If the purported enrollee fails the voice-biometric verification, the method 400 may, in various embodiments, proceed to step 420 for manual verification by the live agent as described above. Otherwise, if the purported enrollee passes the voice-biometric verification at step 418, the purported enrollee may be considered a verified enrollee and the method 400 proceeds to step 422. At step 422, the VAS 110 causes the IVR system 108 to present the alert to the verified enrollee via, for example, TTS functionality of the IVR system 108. After step 422, the method 400 ends.

FIG. 5 shows an illustrative identity-alert method 500 that utilizes full-voice mode. More particularly, the method 500 illustrates exemplary functionality for a system such as, for example, the system 100, when an outbound call from the IVR system 108 is answered by voicemail. One of ordinary skill in the art will appreciate that the method 500 is exemplary and that, in various embodiments, various steps may be substituted, added, or eliminated. The method 500 begins at step 502. In a typical embodiment, steps 502, 504, and 506 are similar to steps 402, 404, and 406, respectively, of FIG. 4. After step 506, the method 500 proceeds to step 508. At step 508, the IVR system 108 determines that the outbound call is answered by voicemail. After step 508, the method 500 proceeds to step 510. At step 510, a voice message may be left that explains that an alert for a particular person is ready for presentation. In typical embodiment, the voice message includes a call-in number and a reference code or password for the alert. After step 510, the method 500 proceeds to step 512.

At step 512, the VAS 110, via the IVR system 108, receives an inbound call from a purported enrollee via the call-in number and prompts the potential enrollee to enter the reference code or password. In a typical embodiment, the VAS 110 verifies the reference code or password and performs voice-biometric verification as described with respect to step 418 of FIG. 4. In various embodiments, the purported enrollee may either opt or be forced to proceed with manual verification by a live agent at step 516 in a manner similar to that described with respect to steps 418 and 420 of FIG. 4. If the purported enrollee passes the voice-biometric verification at step 512, the purported enrollee may be considered a verified enrollee and the method 500 proceeds to step 514. At step 514, the VAS 110 causes the IVR system 108 to present the alert to the verified enrollee via, for example, TTS functionality of the IVR system 108. After step 514, the method 500 ends.

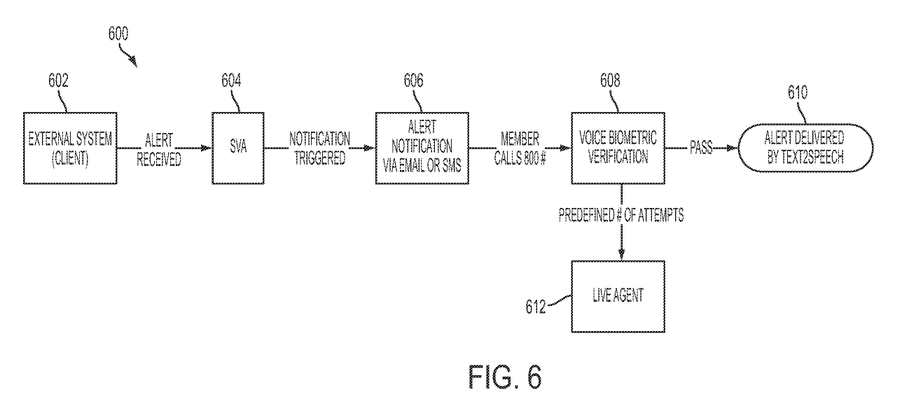

FIG. 6 shows an illustrative identity-alert method 600 that utilizes mixed mode. Mixed-mode identity alerts refer to an identity-alert method that utilizes a combination of two or more means of communication. For example, in the illustrative mixed-mode identity-alert method 600, a combination of voice communication and non-voice communication may be utilized. One of ordinary skill in the art will appreciate that the method 600 is exemplary and that, in various embodiments, various steps may be substituted, added, or eliminated. The method 600 begins at step 602.

At step 602, a system such as, for example, the VAS 110 of FIG. 1, receives an alert for transmission to an enrollee. In various embodiments, the alert may be an identity alert triggered, for example, by a suspicious event identified by the identity-monitoring server 102 of FIG. 1. In various other embodiments, the alert may be an alert provided by an external system such as, for example, the external system 122 of FIG. 1. The external system may be, for example, a system of a financial institution, a governmental entity, or another organization. The external system may access the VAS 110 via, for example, an application programming interface (API) of the VAS 110. After step 602, the method 600 proceeds to step 604.

At step 604, the VAS 110 confirms that an enrollee to whom the alert corresponds is registered to receive voice alerts and has a voiceprint on file in the system 100. If so, the VAS 110 accesses, for example, an email address and/or a mobile-phone number for the enrollee. After step 604, the method 600 proceeds to step 606. At step 606, the VAS 110 may send a message such as, for example, an email message and/or a text message, to the enrollee via the email address and/or the mobile-phone number. In a typical embodiment, the message may contain a call-in number and a reference code or password. After step 606, the method 600 proceeds to step 608.

At step 608, the VAS 110, via the IVR system 108, receives an inbound call from a purported enrollee via the call-in number and prompts the potential enrollee to enter the reference code or password. In a typical embodiment, the VAS 110 verifies the reference code or password and performs voice-biometric verification as described with respect to step 418 of FIG. 4. In various embodiments, the purported enrollee may either opt or be forced to proceed with manual verification by a live agent at step 612 in a manner similar to that described with respect to steps 418 and 420 of FIG. 4. If the purported enrollee passes the voice-biometric verification at step 608, the purported enrollee may be considered a verified enrollee and the method 600 proceeds to step 610. At step 610, the VAS 110 causes the IVR system 108 to present the alert to the verified enrollee via, for example, TTS functionality of the IVR system 108. After step 610, the method 600 ends.

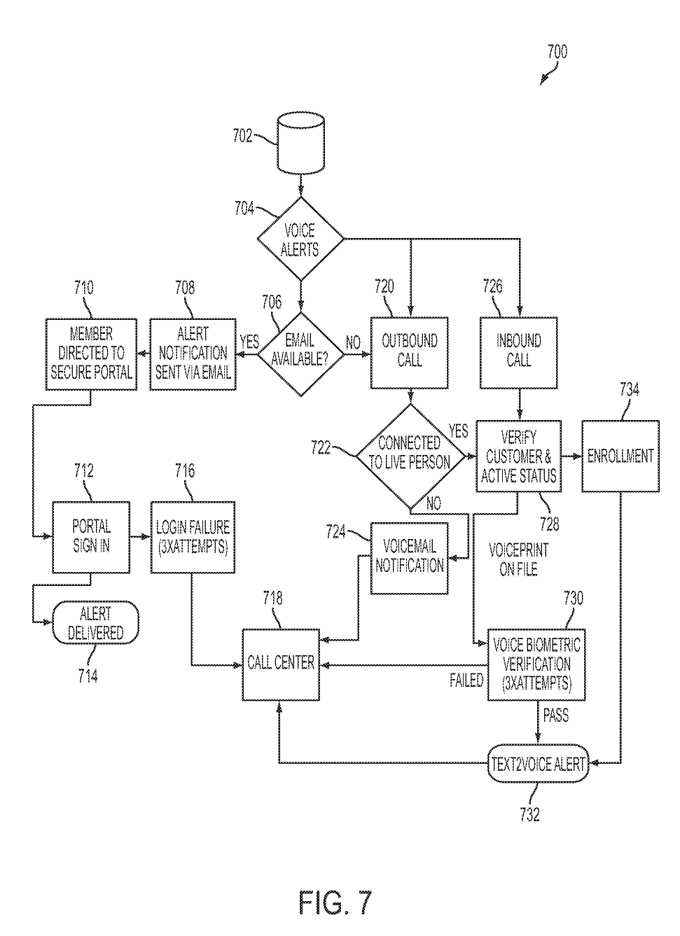

FIG. 7 shows an illustrative identity-alert method 700 that utilizes, for example, the system 100 of FIG. 1. One of ordinary skill in the art will appreciate that the method 700 is exemplary and that, in various embodiments, various steps may be substituted, added, or eliminated. At step 702, an identity-monitoring system such as, for example, the identity-monitoring server 102 of FIG. 1, notifies, for example, the VAS 110 of FIG. 1, of an identified suspicious event for a particular enrollee. After step 702, the method 700 proceeds to step 704. At step 704, the VAS 110 may determine whether an identity alert is merited. In various embodiments, the VAS 110 may allow rules to be established and configured regarding, for example, events that do or do not merit identity alerts. In some embodiments, the rules are further configurable by enrollees. For example, in some embodiments, rule may be configured such that alerts are generated for deemed significant events such as, for example, the opening of a new account, but not for deemed insignificant events such as, for example, a credit inquiry.

If the VAS 110 deems an identity alert to be merited, the VAS 110 may determine a method for delivering an identity alert to the particular enrollee according to a delivery protocol. In various embodiments, the delivery protocol may be based on preferences of the particular enrollee as established, for example, during enrollment into the system 100. In various embodiments, the delivery protocol may be based on a procedure established by an administrator for the system 100. In some embodiments, in order to accommodate enrollees that are uncomfortable with identity alerts delivered by phone or computer, identity alerts may be sent via, for example, paper mail.

For example, if the delivery protocol specifies that a combination of email and a web portal be utilized, the method 700 proceeds from step 704 to step 706. At step 706, the VAS 110 determines if an email address is known for the particular enrollee. If not, the method 700 proceeds to step 720 (described below). Alternatively, if an email address for the particular enrollee is known, the method 700 proceeds to step 708. At step 708, the VAS 110 may send an email message to the email address for the particular enrollee. In a typical embodiment, the email message may contain a notification regarding existence of the identity alert and a uniform resource locator (URL) to a secure web portal. In various embodiments, the email message may further include a reference code or password corresponding to the identity alert. After step 708, the method 700 proceeds to step 710.

At step 710, the VAS 110 serves a web-portal login page to a purported enrollee responsive to the purported enrollee directing a web browser to the URL from the email message. After step 710, the method 700 proceeds to step 712. At step 712, the VAS 110 receives and verifies login credentials from the purported enrollee such as, for example, a user name and a password. In various embodiments, the purported enrollee may be considered a verified enrollee after receipt and verification by the VAS 110 of the login credentials. After successful verification of the login credentials, the method 700 proceeds to step 714. At step 714, the VAS 110 may, for example, serve a webpage to the verified enrollee that includes the identity alert. After step 714, the process 700 ends.

Referring again to step 712, if the login credentials are incorrect, the method 700 may proceed to step 716. At step 716, the VAS 110 may allow a predefined number of additional attempts (e.g., three) to login as described with respect to step 712. If the purported enrollee fails to login within the predefined number of additional attempts, the purported enrollee may be served a webpage directing the purported enrollee to call a call center to speak to a live agent for retrieval of the identity alert. After the purported enrollee fails to login within the predefined number of additional attempts, the method 700 proceeds to step 718. At step 718, the live agent at the call center may manually verify the purported enrollee and, if the manual verification is successful, read or otherwise manually cause the alert to be delivered. The live agent may also provide assistance or support as may requested, for example, with respect to verified enrollees as described in more detail below with respect to step 732. After step 718, the method 700 ends.

Referring again to step 704, if the delivery protocol specifies, for example, that identity-alert delivery be initiated via an outbound call, the method 700 proceeds from step 704 to step 720. At step 720, the VAS 110 accesses, for example, a telephone number for the particular enrollee, and causes the IVR system 108 to initiate an outbound call to the particular enrollee. After step 720, the method 700 proceeds to step 722. At step 722, the IVR system 108 determines a call-answer disposition for the outbound call. If the IVR system 108 determines that the outbound call is answered by voicemail, the method 700 proceeds to step 724. At step 724, a voice message with a call-in number and a reference code or password may be left. At a subsequent time, the particular enrollee may call in to the call-in number and enter the reference code or password for retrieval of the alert.

If the IVR system 108 determines at step 722 that the outbound call is answered by a live person, the live person may be considered a purported enrollee and the method 700 proceeds to step 728. At step 728, the VAS 110 confirms that the particular enrollee to whom the identity alert corresponds is registered to receive voice alerts and has a voiceprint on file in the system 100. If so, the method 700 proceeds to step 730.

At step 730, in a typical embodiment, the VAS 110 causes the IVR system 108 to perform voice-biometric verification of the purported enrollee. In a typical embodiment, the IVR system 108 may prompt the purported enrollee to speak certain utterances (e.g., a random sequence of digits) and analyze the speech against a voiceprint for the particular person to whom the alert corresponds. In various embodiments, an option may be provided to allow the purported enrollee to opt out of voice-biometric verification (e.g., by pressing ‘*’ or speaking “skip”) and be transferred to a live agent for manual verification at step 718. As described above, at step 718, the live agent may manually verify the purported enrollee and, if the manual verification is successful, read or otherwise manually cause the alert to be delivered. After step 718, the method 700 ends.

In a typical embodiment, the IVR system 108 is operable to return a “pass” or a “fail” to the VAS 110 as a result of the voice-biometric verification at step 730. If the purported enrollee fails the voice-biometric verification, the method 700 may, in various embodiments, proceed to step 718 for manual verification by the live agent as described above. Otherwise, if the purported enrollee passes the voice-biometric verification at step 730, the purported enrollee may be considered a verified enrollee and the method 700 proceeds to step 732. At step 732, the VAS 110 causes the IVR system 108 to present the identity alert to the verified enrollee via, for example, TTS functionality of the IVR system 108. In a typical embodiment, the VAS 110 may record that the identity alert has been presented in computer-readable storage. In various embodiments, the VAS 110 may provide an option for the verified enrollee to be routed to a call center for further assistance or support. If the verified enrollee elects to be routed to a call center, the method 700 may proceed to step 718 as described above. Otherwise, after step 732, the method 700 ends.

Referring again to step 728, if the particular enrollee to whom the identity alert corresponds is not registered to receive voice alerts or does not have a voiceprint on file in the system 100, the method 700 proceeds from step 728 to step 734. At step 734, the purported enrollee may be permitted to enroll and register a voiceprint as described, for example, with respect to FIG. 2 or FIG. 3. If the enrollment ends successfully, the purported enrollee may be considered a verified enrollee and the method 700 proceeds to step 732. At step 732, the VAS 110 causes the IVR system 108 to present the identity alert to the verified enrollee via, for example, TTS functionality of the IVR system 108. After step 732, the method 700 ends.

Referring again to step 704, in various embodiments the delivery protocol may allow for identity-alert delivery to be facilitated, for example, by an inbound call from a purported enrollee. For example, the email message sent at step 708 or the voice message left at step 724 may include a call-in number and a reference code or password for the identity alert. In various embodiments, at step 726 the VAS 110, via the IVR system 108, receives an inbound call from the purported enrollee via the call-in number and prompts the potential enrollee to enter the reference code or password. In a typical embodiment, the VAS 110 verifies the reference code or password. After step 726, the method 700 proceeds to step 728 and operates as described above.

One of ordinary skill in the art will appreciate that FIGS. 1-7 and the above descriptions thereof are exemplary in nature and should not be construed as limiting. For example, although FIGS. 1-7 describe various exemplary features of a system capable of delivering identity alerts, one of ordinary skill in the art will recognize that the principles described herein are not limited in scope to delivery of identity alerts. Rather, it is explicitly contemplated that the principles described herein may be applied to delivery of any type of secure message. As used herein, a secure message is any message for which reliable delivery to an intended recipient is desirable. In various embodiments, the secure message be, for example, a message that contains PII, medical information, insurance information, legal information, or any other information that may be deemed sensitive under a particular set of facts. Similarly, other applications will be apparent to one of ordinary skill in the art after studying the foregoing description.

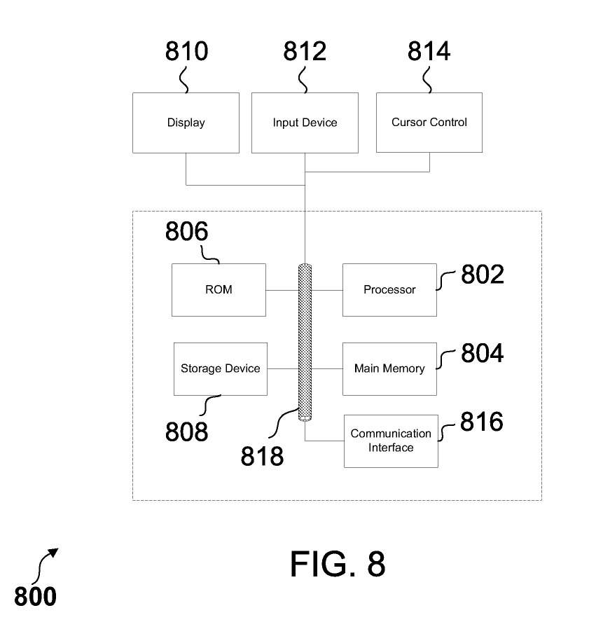

FIG. 8 illustrates an embodiment of a computer system 800 on which various embodiments of the invention may be implemented such as, for example, the process 200 of FIG. 2, the process 300 of FIG. 3, the process 400 of FIG. 4, the process 500 of FIG. 5, the process 600 of FIG. 6, and/or the process 700 of FIG. 7. The computer system 800 may be, for example, similar to the identity-monitoring system 102, the identity-authentication server 104, the communication device 106, the IVR system 108, the VAS 110, the computer 120, and/or the external system 122, each of which is described above with respect to FIG. 1. The computer system 800 may be a physical system, virtual system, or a combination of both physical and virtual systems. In the implementation, a computer system 800 may include a bus 818 or other communication mechanism for communicating information and a processor 802 coupled to the bus 818 for processing information. The computer system 800 also includes a main memory 804, such as random-access memory (RAM) or other dynamic storage device, coupled to the bus 818 for storing computer readable instructions by the processor 802.

The main memory 804 also may be used for storing temporary variables or other intermediate information during execution of the instructions to be executed by the processor 802. The computer system 800 further includes a read-only memory (ROM) 806 or other static storage device coupled to the bus 818 for storing static information and instructions for the processor 802. A computer-readable storage device 808, such as a magnetic disk or optical disk, is coupled to the bus 818 for storing information and instructions for the processor 802. The computer system 800 may be coupled via the bus 818 to a display 810, such as a liquid crystal display (LCD) or a cathode ray tube (CRT), for displaying information to a user. An input device 812, including, for example, alphanumeric and other keys, is coupled to the bus 818 for communicating information and command selections to the processor 802. Another type of user input device is a cursor control 814, such as a mouse, a trackball, or cursor direction keys for communicating direct information and command selections to the processor 802 and for controlling cursor movement on the display 810. The cursor control 814 typically has two degrees of freedom in two axes, a first axis (e.g., x) and a second axis (e.g., y), that allow the device to specify positions in a plane.

The term “computer readable instructions” as used above refers to any instructions that may be performed by the processor 802 and/or other component of the computer system 800. Similarly, the term “computer readable medium” refers to any storage medium that may be used to store the computer readable instructions. Such a medium may take many forms, including, but not limited to, non volatile media, volatile media, and transmission media. Non-volatile media include, for example, optical or magnetic disks, such as the storage device 808. Volatile media includes dynamic memory, such as the main memory 804. Transmission media includes coaxial cables, copper wire, and fiber optics, including wires of the bus 818. Transmission media can also take the form of acoustic or light waves, such as those generated during radio frequency (RF) and infrared (IR) data communications. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EPROM, any other memory chip or cartridge, a carrier wave, or any other medium from which a computer can read.

Various forms of the computer readable media may be involved in carrying one or more sequences of one or more instructions to the processor 802 for execution. For example, the instructions may initially be borne on a magnetic disk of a remote computer. The remote computer can load the instructions into its dynamic memory and send the instructions over a telephone line using a modem. A modem local to the computer system 800 can receive the data on the telephone line and use an infrared transmitter to convert the data to an infrared signal. An infrared detector coupled to the bus 818 can receive the data carried in the infrared signal and place the data on the bus 818. The bus 818 carries the data to the main memory 804, from which the processor 802 retrieves and executes the instructions. The instructions received by the main memory 804 may optionally be stored on the storage device 808 either before or after execution by the processor 802.

The computer system 800 may also include a communication interface 816 coupled to the bus 818. The communication interface 816 provides a two-way data communication coupling between the computer system 800 and a network. For example, the communication interface 816 may be an integrated services digital network (ISDN) card or a modem used to provide a data communication connection to a corresponding type of telephone line. As another example, the communication interface 816 may be a local area network (LAN) card used to provide a data communication connection to a compatible LAN. Wireless links may also be implemented. In any such implementation, the communication interface 816 sends and receives electrical, electromagnetic, optical, or other signals that carry digital data streams representing various types of information. The storage device 808 can further include instructions for carrying out various processes as described herein when executed by the processor 802. The storage device 808 can further include a database for storing data relative to same.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A method comprising:
enrolling a potential enrollee for an identity-monitoring service, the enrolling comprising acquiring personally-identifying information (PII) and capturing a voiceprint;
wherein, following successful completion of the enrolling, the potential enrollee is an enrollee;
responsive to an identified suspicious event related to the PII:
creating an identity alert;
establishing voice communication with an individual purporting to be the enrollee;
performing voice-biometric verification of the individual, the voice-biometric verification comprising comparing one or more spoken utterances with the voiceprint;
wherein, following successful completion of the voice-biometric verification, the individual is a verified enrollee; and
authorizing delivery of the identity alert to the verified enrollee.

2. The method of claim 1, wherein the enrolling comprises a mixed-mode enrollment, the mixed-mode enrollment comprising:
acquiring the PII from the individual via non-voice communication over a computer network; and
capturing the voiceprint from the individual via voice communication.

3. The method of claim 1, wherein the enrolling comprises verifying the PII, the verifying comprising at least one selected from the group consisting of:
verifying existence of the PII;
verifying consistency of the PII; and
verifying that the PII does not correspond to a known stolen identity.

4. The method of claim 3, wherein the verifying comprises:
generating a score for the PII, the score representing a relative confidence in at least one selected from the group consisting of:
that the PII exists;
that the PII is consistent; and
that the PII does not correspond to a known stolen identity;
comparing the score to a pre-established threshold; and
wherein the successful completion of the enrolling requires the score to exceed the predetermined threshold.

5. The method of claim 4, wherein the verifying comprises, responsive to the score failing to exceed the predetermined threshold, allowing the individual at least one additional attempt to pass the verification.

6. The method of claim 1, wherein the enrolling comprises authenticating the individual as an owner of the PII, the authenticating comprising:
presenting knowledge-based authentication (KBA) questions related to the enrollee;
receiving answers to the KBA questions; and
verifying the answers to the KBA questions.

7. The method of claim 1, wherein the enrolling comprises associating the voiceprint with a unique identifier for the enrollee.

8. The method of claim 1, wherein the enrolling comprises:
providing a menu of options to the enrollee for delivery of identity alerts; and
receiving, from the enrollee, a selection from the menu of options.

9. The method of claim 1, wherein establishing voice communication comprises causing an outbound call to be placed to the enrollee.

10. The method of claim 1, wherein establishing voice communication comprises:
causing a notification to be sent to the enrollee, the notification comprising a call-in number for an inbound call; and
receiving an inbound call from the individual.

11. The method of claim 10, wherein the notification comprises at least one selected from the group consisting of: a voicemail, a text message, and an email message.

12. The method of claim 1, wherein the enrollment is facilitated via a computer residing at a kiosk, the kiosk being operated by an agent for a business.

13. The method of claim 1, wherein acquiring PII comprises acquiring the PII via an online data form over the Internet.

14. The method of claim 13, wherein:
the enrolling comprises:
prompting the potential enrollee, via the Internet, to choose between placing an inbound call to an interactive voice-response (IVR) system and having the IVR system place an outbound call to the individual;
receiving a selection from the individual responsive to the prompting; and
responsive to the selection, placing an outbound call or receiving an inbound call; and
the capturing comprises capturing a voiceprint via the inbound call or the outbound call.

15. The method of claim 1, wherein acquiring PII comprises loading the PII from an import file.

16. The method of claim 1, wherein the identified suspicious event is received from an external system via an application programming interface (API).

17. The method of claim 1, wherein creating an identity alert comprises evaluating the identified suspicious event to determine whether an identity alert is merited.

18. The method of claim 1, the method comprising, responsive to the voice-biometric verification ending in failure, allowing the individual at least one additional attempt to successfully complete the voice-biometric verification.

19. The method of claim 18, the method comprising, responsive to the individual failing to pass the voice-biometric verification after a predefined number of attempts, routing the individual to a live agent for manual verification.

20. The method of claim 1, the method comprising delivering the identity alert to the verified enrollee.

21. The method of claim 20, the method comprising delivering the identity alert to the verified enrollee via text-to-speech (TTS) technology.

22. A voice-biometric system comprising:
an interactive voice-response (IVR) system operable to exchange voice communication with a communication device over a network;
a voice-alert system (VAS) communicably coupled to the IVR system via a computer network, the VAS operable, in conjunction with the IVR system, to:
enroll a potential enrollee for an identity-monitoring service, the enrollment comprising acquiring personally-identifying information (PII) and capturing a voiceprint;
wherein, following successful completion of the enrolling, the potential enrollee is an enrollee;
responsive to an identified suspicious event related to the PII:
create an identity alert;
establish voice communication with an individual purporting to be the enrollee;
perform voice-biometric verification of the individual, the voice-biometric verification comprising comparing one or more spoken utterances with the voiceprint;
wherein, following successful completion of the voice-biometric verification, the individual is a verified enrollee; and
authorize delivery of the identity alert to the verified enrollee.

23. The voice-biometric system of claim 22, wherein the VAS is operable to acquire the PII via an online data form over the Internet.

24. The voice-biometric system of claim 22, wherein:
the IVR system is operable to perform text-to-speech (TTS) conversion, automated speech recognition (ASR), and DTMF signaling to recognize touch-tone responses; and
the VAS is operable, in conjunction with the IVR system, to acquire the PII via at least one of the following: TTS conversion, ASR, and DTMF signaling.

25. The voice-biometric system of claim 22, wherein the VAS is operable to load the PII from an import file.

26. The voice-biometric system of claim 22, the voice-biometric system comprising:
an enrollee database;
wherein the VAS is operable to cause the voice print to be stored in the enrollee database.

27. The voice-biometric system of claim 22, wherein the VAS comprises an application programming interface (API) operable to receive an alert from an external computer system, the created identity alert comprising the received alert.

28. The voice-biometric system of claim 22, the voice-biometric system comprising an identity-monitoring system, the identity-monitoring system operable to identify suspicious events related to the PII.

29. The voice-biometric system of claim 22, the voice-biometric system comprising an identity-verification server, the identity-verification server operable to authenticate the individual as an owner of the PII, the authentication comprising:
presentation of knowledge-based authentication (KBA) questions related to the enrollee;
receipt of answers to the KBA questions; and
verification of the answers to the KBA questions.

30. The voice-biometric system of claim 22, wherein the VAS is operable to deliver the identity alert via a web portal over the Internet.

31. The voice-biometric system of claim 22, wherein:
the IVR system is operable to perform text-to-speech (TTS) conversion, automated speech recognition (ASR), and DTMF signaling to recognize touch-tone responses; and
the VAS is operable, in conjunction with the IVR system, to deliver the identity alert via TTS conversion.

32. The voice-biometric system of claim 22, wherein establishment of voice communication comprises:
a notification sent to the enrollee, the notification comprising a call-in number for an inbound call; and
receipt of an inbound call from the individual to the IVR system.

33. The voice-biometric system of claim 33, wherein:
the notification comprises at least one selected from the group consisting of: a voicemail, a text message, and an email message; and
wherein the VAS, in conjunction with the IVR system, is operable to send the notification.

34. A computer-program product comprising a computer-usable medium having computer-readable program code embodied therein, the computer-readable program code adapted to be executed to implement a method comprising:
enrolling a potential enrollee for an identity-monitoring service, the enrolling comprising acquiring personally-identifying information (PII) and capturing a voiceprint;
wherein, following successful completion of the enrolling, the potential enrollee is an enrollee;
responsive to an identified suspicious event related to the PII:
creating an identity alert;
establishing voice communication with an individual purporting to be the enrollee;
performing voice-biometric verification of the individual, the voice-biometric verification comprising comparing one or more spoken utterances with the voiceprint;
wherein, following successful completion of the voice-biometric verification, the individual is a verified enrollee; and
authorizing delivery of the identity alert to the verified enrollee.
